(19) United States
(12) Patent Application Publication
(10) Pub. No.: US 2003/0053753 A1
(43) Pub. Date: Mar. 20, 2003

(54) Optical device having a grated coupler and a method of manufacture therefor

(75) Inventor: Yongqiang Shi, Diamond Bar, CA (US)

Correspondence Address: HITT GAINES & BOISBRUN P.C., P.O. BOX 832570, RICHARDSON, TX, 75083, US

(73) Assignee: Agere Systems Inc., Allentown, PA (US)

(21) Appl. No.: 10/246,103

(22) Filed: Sep. 18, 2002

Related U.S. Application Data
(60) Provisional application No. 60/323,401, filed on Sep. 19, 2001.

(51) Int. Cl. G02B 6/34

(52) U.S. Cl. 385/37

(57) ABSTRACT

The present invention provides an optical device and a method of manufacture therefor. In one advantageous embodiment, the optical device may include a waveguide located within a substrate, wherein the waveguide has an index of refraction. The optical device may further include a grated coupler located over the waveguide, such that the grated coupler redirects a portion of radiation passing through the waveguide out of the waveguide, and a detector located over the grated coupler that receives the redirected portion. Advantageously, the grated coupler may have an index of refraction different than the index of refraction of the waveguide.

### CROSS-REFERENCE TO PROVISIONAL APPLICATION

This application claims the benefit of U.S. Provisional Application No. 60/323,401 entitled “MODULATOR HAVING A GRATED COUPLER AND A METHOD OF MANUFACTURE THEREFOR,” to Yongqiang Shi, filed on Sep. 19, 2002, which is commonly assigned with the present invention and incorporated herein by reference as if reproduced herein in its entirety.

### TECHNICAL FIELD OF THE INVENTION

The present invention is directed, in general, to an optical communications system and, more specifically, to an optical device having a grated coupler and a method of manufacture therefor.

### BACKGROUND OF THE INVENTION

Certain types of waveguide based optical switches, also referred to as optical modulators, are commonly used in today's optical communications systems. An optical modulator is generally known as a device that modulates or varies an amplitude of an optical signal passing therethrough. Such optical modulators have many different uses in today's optical communications systems. For example, high-speed optical modulators are used to encode information into an optical signal generated by an optical source, such as an optical laser, where the information is represented by changes in the amplitude of the optical signal. Additionally, low-speed optical modulators (also referred to as optical attenuators), may be used in conjunction with an optical amplifier to control the overall gain of an amplifier stage. This is generally used to account for gradual changes in a received optical signal, for example, as an optical source ages.

There is currently a desire to monitor a modulated optical signal exiting the modulator. If the modulated optical signal exiting the modulator may be monitored, the modulated optical signal may be precisely tailored for a particular use. Without the ability to monitor the modulated optical signal and make adjustments according to the monitored signal, the actual modulated optical signal being provided to an optoelectronic device may only be an educated guess.

In prior attempts to monitor the modulated optical signal exiting the modulator, the optoelectronic industry has employed a waveguide tap. The waveguide tap is coupled to an edge face of the waveguide, and redirects a small portion of the modulated optical signal exiting the waveguide to an external device, such that it may be monitored. While the waveguide tap allows the modulated signal to be monitored, it has certain drawbacks. One of such drawbacks is that it limits the waveguide design to one that is compatible with the waveguide tap. Another drawback is that waveguide tap is difficult and costly to manufacture, and may be hard to efficiently couple to the waveguide.

Accordingly, what is needed in the art is a device for monitoring an optical signal, for example produced by an optoelectronic device, and a method of manufacture therefor, that does not experience the problems experienced by the prior art devices.

### SUMMARY OF THE INVENTION

To address the above-discussed deficiencies of the prior art, the present invention provides an optical device and a method of manufacture therefor. In one advantageous embodiment, the optical device may include a waveguide located within a substrate, wherein the waveguide has an index of refraction. The optical device may further include a grated coupler located over the waveguide, such that the grated coupler redirects a portion of radiation passing through the waveguide out of the waveguide, and a detector located over the grated coupler that receives the redirected portion. Advantageously, the grated coupler may have an index of refraction different than the index of refraction of the waveguide.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a cross-sectional view of an optical device, which has been constructed according to the principles of the present invention;

FIG. 2 illustrates a cross-sectional view of a partially completed optical device, which is in accordance with the principles of the present invention;

FIG. 3 illustrates the partially completed optical device illustrated in FIG. 2, after formation of a grated coupler within the waveguide;

FIG. 4 illustrates the partially completed optical device illustrated in FIG. 3, after formation of a grated coupler material layer over the waveguide and the grated coupler;

FIG. 5 illustrates a partially completed optical device, which is in accordance with the principles of the present invention;

FIG. 6 illustrates the partially completed optical device illustrated in FIG. 5, after formation of a grated coupler within the grated coupler material layer;

FIG. 7 illustrates the partially completed optical device shown in FIG. 6, after conventional formation of a gap fill layer;

FIG. 8 illustrates the partially completed optical device shown in FIG. 7, after conventional planarization of the gap fill layer;

FIG. 9 illustrates an embodiment of an optical communications system that is in accordance with the principles of the present invention;

FIG. 10 illustrates a cross-sectional view of an optical communications system, which may form one environment in which an optical device that is in accordance with the principles of the present invention, may be used; and

FIG. 11 illustrates an alternative optical communications system, having a repeater, including a second transmitter and a second receiver, located between the transmitter and the receiver.

### DETAILED DESCRIPTION

Referring initially to FIG. 1, illustrated is a cross-sectional view of an optical device 100, which has been constructed according to the principles of the present invention. In one particularly beneficial embodiment of the present invention, the optical device 100 comprises a modulator. However, it should be noted that other types of optical devices (e.g., silica waveguides, planar waveguide structures, etc.) are within the scope of the present invention. In the illustrative embodiment shown in FIG. 1, the optical device 100 includes a substrate 110. One skilled in the art understands that the substrate 110 may comprise many different materials. For example, in an exemplary embodiment, the substrate 110 comprises an electrooptic crystal substrate, such as a lithium niobate substrate or another similar substrate.

Located within the substrate 110, in the embodiment shown in FIG. 1, is a waveguide 120. The waveguide 120, which may be a metal-diffused, proton exchanged, epitaxial grown or any other known or hereafter discovered waveguide, has an index of refraction associated therewith. In an exemplary embodiment of the invention, the substrate 110 is a lithium niobate substrate and the waveguide 120 is a titanium diffused waveguide located within the substrate 110. It should be noted, however, any substrate 110 and waveguide 120 combination that is consistent with the design of the optical device 100, is within the scope of the present invention.

In an advantageous embodiment, a grated coupler 130 is located over or within the waveguide 120. The grated coupler 130 may include any surface perturbation in or above the waveguide 120 that is designed to redirect light away from the waveguide 120, and that has an index of refraction different from the waveguide. The redirecting perturbations may include a material or a gas that has an index of refraction that is different from the waveguide 120. It should be noted that the perturbations may be formed into the waveguide 120 itself or be formed from a material that comprises the grated coupler 130.

In the embodiment illustrated in FIG. 1, the grated coupler 130 redirects a portion of radiation 135 passing through the waveguide 120, outside of the waveguide 120. Without the grated coupler 130, and an associated change in index of refraction between the waveguide 120 and a medium located thereover, the radiation 135 would stay coupled within the waveguide 120 and exit the waveguide 120 at an edge face 123. However, in contrast to the prior art, the grated coupler 130 may cause a portion of the radiation 135 to be redirected out a surface 127 that is normal to the edge face 123. In the current example, it is important that only a portion of the radiation 135 be redirected, and that a remaining portion of the radiation 135 continue through the waveguide 120. This allows the optical device 100 to be operating while the redirected portion is tested for accuracy.

Further included in the illustrative embodiment shown in FIG. 1 is a grated coupler material layer 140 located over the waveguide 120. The grated coupler material layer 140 may comprise many materials, however, in one particularly advantageous embodiment the grated coupler material layer 140 comprises a dielectric material, such as silicon dioxide. As mentioned above, the grated coupler material layer 140 may have an index of refraction different from the index of refraction of the waveguide 120.

Located over the grated coupler 130, and in a position to receive a portion of the redirected radiation, may be a detector 150. The detector 150, which may comprise a photodetector or any other means for observing the redirected radiation, allows the redirected radiation to be monitored. Because the redirected radiation may be monitored, an assurance may be obtained that the radiation 135 passing through the waveguide 120 is as desired.

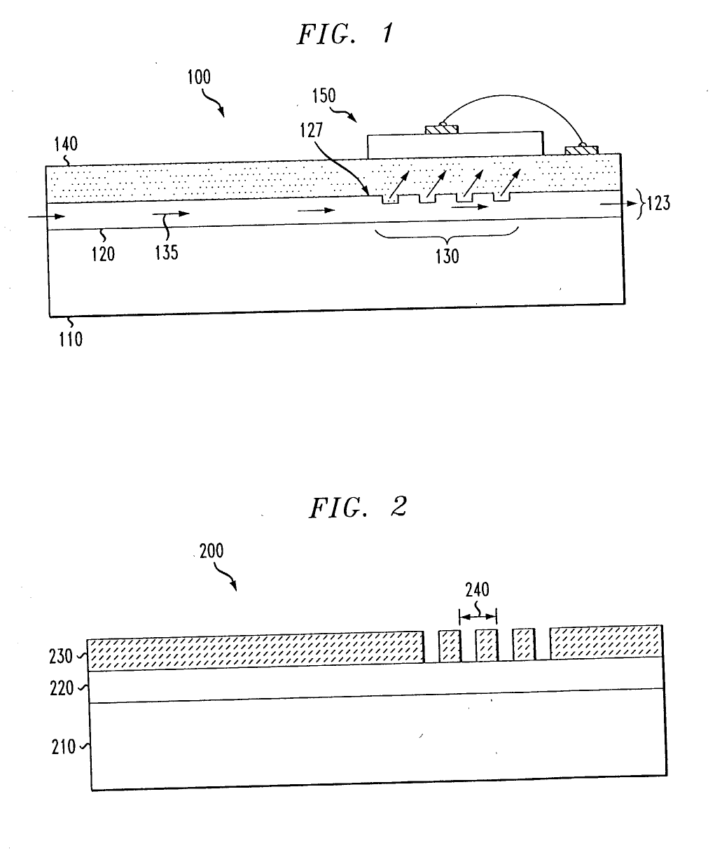

Turning now to FIGS. 2-4, illustrated are cross-sectional views of detailed manufacturing steps illustrating how an exemplary embodiment of an optical device, similar to the optical device 100 illustrated in FIG. 1, may be manufactured. FIG. 2 illustrates a cross-sectional view of a partially completed optical device 200, which is in accordance with the principles of the present invention. The partially completed optical device 200 includes a substrate 210 having a waveguide 220 formed therein. As previously recited, the substrate 210 and waveguide 220 may comprise various materials. For example, in the illustrative embodiment shown herein, the substrate 210 is a lithium niobate substrate and the waveguide 220 is a titanium-diffused waveguide. While examples have been given, the present invention should not be limited to such examples. For example, silicon or silica substrates having various other waveguides structures therein are well within the scope of the present invention.

The substrate 210 and waveguide 220 may have varying thicknesses. In one particular example, the substrate 210 has a thickness ranging from about 100 μm to about 1000 μm, and the waveguide 220 has a thickness ranging from about 1 μm to about 10 μm. While thicknesses of the substrate 210 and waveguide 220 have been given, one skilled in the art understands that such thicknesses are generally dependent on the specific design of the device.

Located over the waveguide 220, in the illustrative embodiment shown in FIG. 2, are conventionally formed photoresist portions 230. Since the photoresist portions 230 may ultimately be used to form a grated coupler (FIG. 3), their spacing is of particular importance. For example, in an exemplary embodiment, the following equation may be used to choose the spacing of the photoresist portions:

$$Λ = \frac{λ}{( {n}_{eff} - cos θ )}$$

wherein Λ is the periodicity of the openings, λ is the operating wavelength of the optical device 200, n_{eff} is the index of refraction of the waveguide 220, and θ is a desired angle that the radiation exits the waveguide 220. In one illustrative example, λ=1550 nm, n_{eff}=2.15, and θ=45 degrees, resulting in a periodicity 240 of about 1090 nm. One understands, however, that any of the elements of the equation may be varied, resulting in a different periodicity 240. For example, in an exemplary embodiment θ may range from about 25 degrees to about 160 degrees, resulting in a periodicity 240 ranging from about 400 nm to about 1200 nm.

Turning to FIG. 3, illustrated is the partially completed optical device 200 illustrated in FIG. 2, after formation of a grated coupler 310 within the waveguide 220. The grated coupler 310 may be defined using various techniques. For example, a reactive ion etch (RIE), a reactive ion beam etch (RIBE), ion milling, a wet etch, or another similar etch, may be used to define the grated coupler 310 through the photoresist portions 230. Such techniques are generally well known in the art. After the grated coupler 310 is defined, the photoresist portions 230 are generally removed.

A depth at which the grated coupler 310 extends into the waveguide 220 may provide desirable benefits. For example, the depth at which the grated coupler 310 extends into the waveguide 220 may determine the amount of radiation that is redirected out of the waveguide 220. For a larger amount of redirected radiation, the depth should be increased, and for a smaller amount of redirected radiation, the depth should be decreased. In the illustrative embodiment, however, the depth at which the grated coupler extends into the waveguide 220 ranges from about 100 nm to about 500 nm.

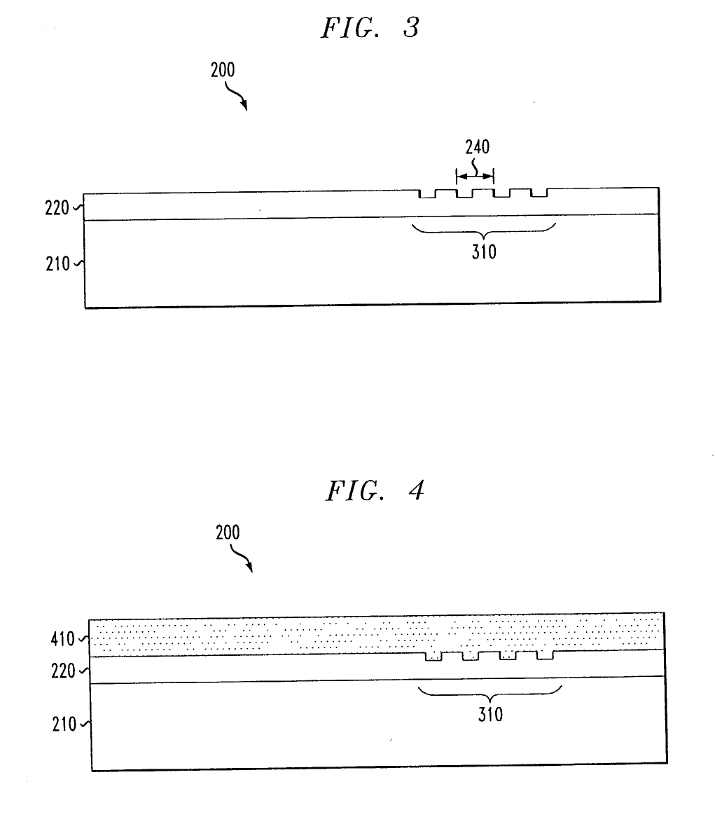

Turning to FIG. 4, illustrated is the partially completed optical device 200 illustrated in FIG. 3, after formation of a grated coupler material layer 410 over the waveguide 220 and the grated coupler 310. The grated coupler material layer 410 should have an index of refraction different from that of the waveguide 220. In one exemplary embodiment, the waveguide 220 is a diffused lithium niobate waveguide and the grated coupler material layer 410 comprises a material having a lower index of refraction, such as silicon dioxide, calcium fluoride, sapphire, indium tin oxide, air or another similar material. However, in an alternative embodiment, the grated coupler material layer 410 comprises a material having a higher index of refraction, such as silicon, gallium arsenide, gallium phosphate, indium phosphate, germanium or another similar material. After forming the grated coupler material layer 410, a detector could be positioned over the grated coupler 310, resulting in an optical device similar to the optical device 100 shown in FIG. 1.

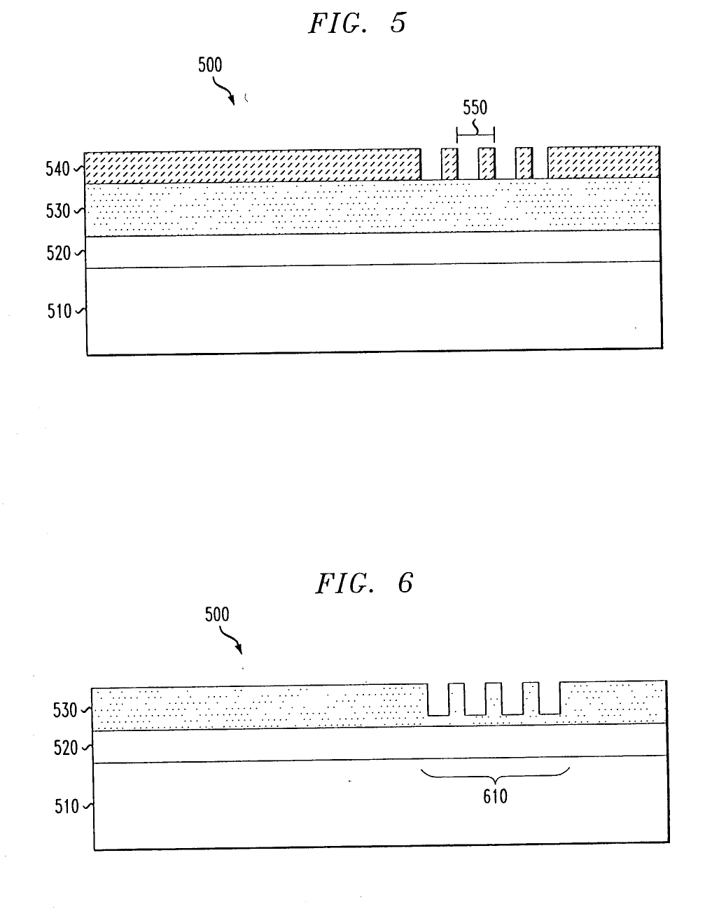

Turning now to FIGS. 5-8, illustrated are cross-sectional views of detailed manufacturing steps illustrating how one skilled in the art might, in an exemplary embodiment, manufacture an alternative embodiment of the optical device 100 illustrated in FIG. 1. FIG. 5 illustrates a partially completed optical device 500, which is in accordance with the principles of the present invention. In the illustrative embodiment shown in FIG. 5, the optical device 500 includes a substrate 510 having a waveguide 520 formed thereover. The substrate 510 and waveguide 520 may have similar properties, including thickness and material type, as the substrate 210 and waveguide 220 illustrated in FIG. 2.

Located over the waveguide 520 in the illustrative embodiment shown in FIG. 5, is a grated coupler material layer 530. The grated coupler material layer 530, which may be a dielectric layer and act as a confinement layer for the waveguide 520, may comprise any material having an index of refraction different from the waveguide 520. Similar to the grated coupler material layer 410 illustrated in FIG. 4, the grated coupler material layer 530 may comprise a material having a lower index of refraction, such as silicon dioxide, calcium fluoride, sapphire, indium tin oxide, air or another similar material. However, in an alternative embodiment, the grated coupler material layer 530 may locally comprise a material having a higher index of refraction, such as silicon, gallium arsenide, gallium phosphate, indium phosphate, germanium or another similar material.

Conventionally formed over the grated coupler material layer 530 are photoresist portions 540. The photoresist portions 540 may be formed using a similar process as used to form the photoresist portions 230 (FIG. 2). Likewise, the photoresist portions 540 may have a periodicity 550, wherein the periodicity 550 may be calculated in a similar fashion as the periodicity 240 (FIG. 2).

Turning to FIG. 6, illustrated is the partially completed optical device 500 illustrated in FIG. 5, after formation of a grated coupler 610 within the grated coupler material layer 530. The grated coupler 610 may be defined using various techniques. For example, RIE, RIBE, ion milling, wet etch, or another similar etch, may be used to define the grated coupler 610 through the photoresist portions 540. Such techniques are generally well known in the art.

The depth at which the grated coupler 610 extends into the grated coupler material layer 530 may vary according to the amount of radiation that is desired to be redirected out of the waveguide 520. For example, a large depth provides a larger amount of redirected radiation, and a small depth provides a lesser amount of redirected radiation. It should be understood that the amount of desired redirected radiation depends on the design of the device. However, in one particular embodiment, the amount of desired redirected radiation may require the grated coupler 610 to extend into the grated coupler material layer 530 to a depth ranging from about 300 nm to about 1500 nm. After completion of the grated coupler 610, the photoresist portions 540 are generally removed.

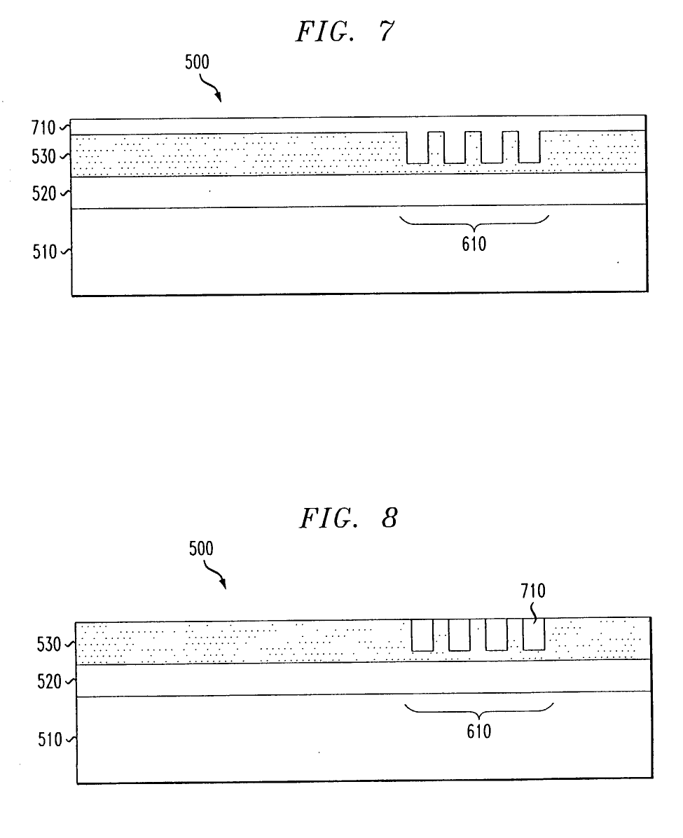

Turning to FIG. 7, illustrated is the partially completed optical device 500 shown in FIG. 6, after conventional formation of a gap fill layer 710. The gap fill layer 710 may comprise any material that has an index of refraction different from the index of refraction of the material layer 530. In one particular embodiment, however, the gap fill layer 710 comprises a material with an index of refraction greater than an index of refraction of the grated coupler material layer 530. In an alternative embodiment, the gap fill layer 710 is not required, leaving air to act as the gap fill layer 710, and as the medium by which the radiation travels.

Turning to FIG. 8, illustrated is the partially completed optical device 500 shown in FIG. 7, after conventional planarization of the gap fill layer 710. As illustrated in the embodiment shown in FIG. 8, the gap fill layer 710 may only remain in gaps of the grated coupler 610. One skilled in the art understands how to planarize the gap fill layer 710, including using a conventional chemical mechanical planarization, or other similar processes, to accomplish the task. Typically, after completion of the gap fill layer 710, an electrode and a detector could be positioned adjacent the waveguide 520.

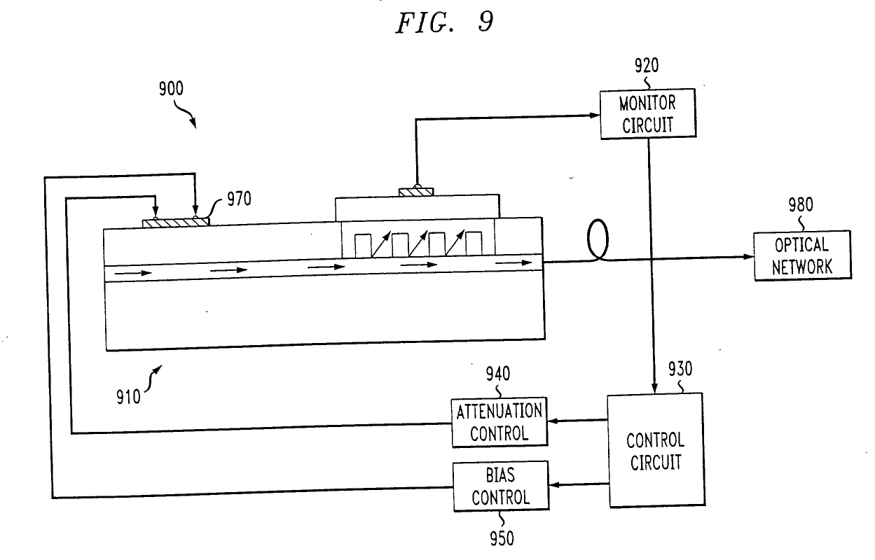

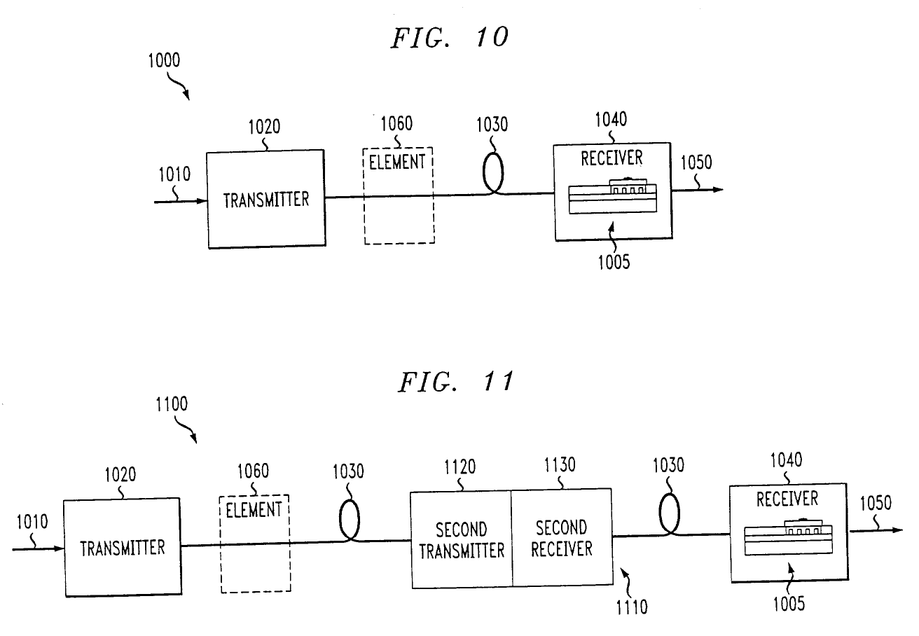

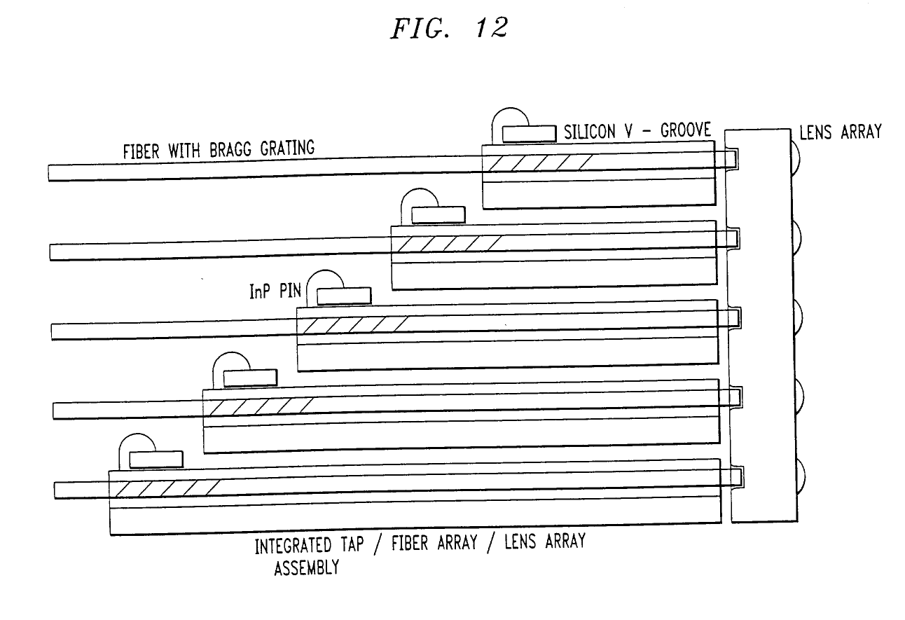

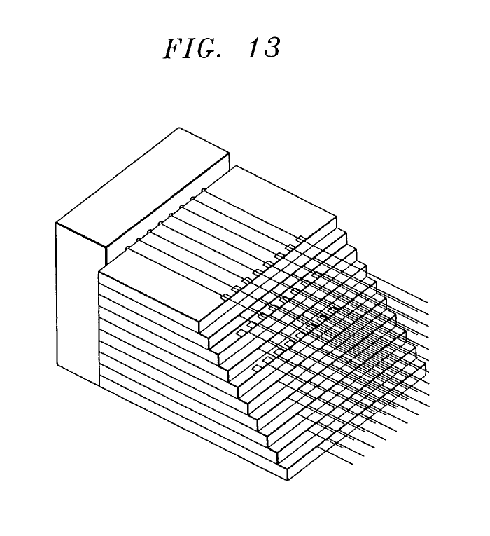

Turning to FIG. 9, illustrated is an embodiment of an optical communications system 900 that is in accordance with the principles of the present invention. The optical communications system 900 includes an optical device 910, which may be similar to the optical device 100 illustrated in FIG. 1. The optical communications system 900 may further include a monitor circuit 920 coupled to a detector of the optical device 910. The monitor circuit 920 may be used to monitor radiation redirected away from the optical device 910.

The optical communications system 900 shown in FIG. 9 may further include a control circuit 930 coupled to the monitor circuit 920. The control circuit 930 may take a signal generated by the monitor circuit 920 and determine whether radiation passing through the optical device 910 is as desired. If the radiation passing through the optical device 910 is as desired, the control circuit 930 may continue to receive signals from the monitor circuit 920 without taking action. If the radiation passing through the optical device 910 is not as desired, the control circuit 930 may direct an attenuation control 940 or bias control 950 to attenuate or bias the radiation passing through the optical device 910. The attenuation control and bias control 950 are generally coupled to an electrode 970 associated with the optical device 910. In such an instance, the control circuit 930 may vary the attenuation control 940 or bias control 950 until the monitor circuit 920 provides a signal as desired.

While a portion of the radiation may be redirected to the monitoring circuit 920, a remainder of the radiation may be simultaneously routed to another device, such as an optical network 980. As such, the present invention easily allows one to monitor an output of an optical device 900 during operation thereof, without experiencing many of the problems associated with the prior art devices.

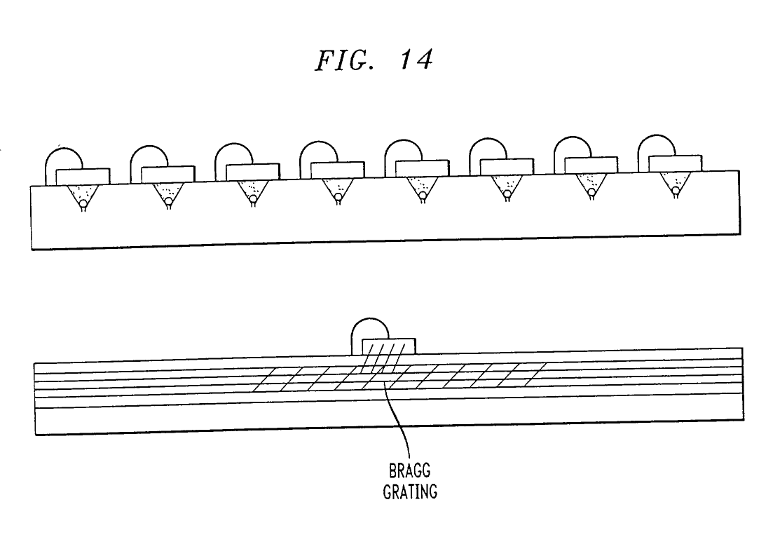

Turning to FIG. 10, illustrated is a cross-sectional view of an optical communications system 1000, which may form one environment in which an optical device 1005 that is in accordance with the principles of the present invention, may be used. An initial signal 1010 enters a transmitter 1020 of the optical communications system 1000. The transmitter 1020, receives the initial signal 1010, addresses the signal 1010 and sends the resulting information across an optical fiber 1030 to a receiver 1040. The receiver 1040 receives the information from the optical fiber 1030, addresses the information, and sends an output signal 1050. As illustrated in FIG. 10, the optical device 1005 may be included within the receiver 1040. The optical device 1005 may also be included anywhere in the optical communications system 1000, including the transmitter 1020. It should be noted that the optical communications system 1000 is not limited to the devices previously mentioned. For example, the optical communications system 1000 may include an element 1060, such as a laser, diode, modulator, optical amplifier, optical waveguide, photodetectors, or other similar device.

Turning briefly to FIG. 11, illustrated is an alternative optical communications system 1100, having a repeater 1110, including a second transmitter 1120 and a second receiver 1130, located between the transmitter 1020 and the receiver 1040. As illustrated, the alternative optical communications system 1100 may also include the optical device 1005.

Although the present invention has been described in detail, those skilled in the art should understand that they can make various changes, substitutions and alterations herein without departing from the spirit and scope of the invention in its broadest form.

What is claimed is:

1. An optical device, comprising:
a waveguide located within a substrate and having an index of refraction;
a grated coupler located over the waveguide and having an index of refraction different than the index of refraction of the waveguide, such that the grated coupler redirects a portion of radiation passing through the waveguide out of the waveguide; and
a detector located over the grated coupler that receives the redirected portion.

2. The optical device as recited in claim 1 wherein the grated coupler has a periodicity based on the equation:
$$Λ = \frac{λ}{( {n}_{eff} - cos θ )}$$
wherein Λ is the periodicity, λ is the operating wavelength of the device, n_{eff} is the index of refraction of the waveguide, and θ is a desired angle that the radiation exits the waveguide.

3. The optical device as recited in claim 2 wherein the desired angle ranges from about 45 degrees to about 160 degrees.

4. The optical device as recited in claim 2 wherein the periodicity ranges from about 400 nm to about 1200 nm.

5. The optical device as recited in claim 1 wherein the grated coupler is located at least partially within the waveguide.

6. The optical device as recited in claim 1 further including a dielectric layer located over the waveguide, wherein the grated coupler is located at least partially within the dielectric layer.

7. The optical device as recited in claim 1 wherein the substrate is an electrooptic crystal substrate, the waveguide is a metal-diffused, proton exchanged, or epitaxial grown waveguide, and wherein the optical device further includes an electrode located at least partially adjacent the waveguide.

8. The optical device as recited in claim 1 wherein the grated coupler comprises a material selected from the group consisting of:
silicon dioxide;
calcium fluoride;
sapphire;
indium tin oxide; and
air.

9. The optical device as recited in claim 1, further including an optical waveguide coupled to the optical device, wherein the optical device and the optical waveguide form at least a portion of an optical communications system.

10. A method of manufacturing an optical device, comprising:
creating a waveguide within a substrate and having an index of refraction;
forming a grated coupler over the waveguide and having an index of refraction different than the index of refraction of the waveguide, such that the grated coupler redirects a portion of radiation passing through the waveguide out of the waveguide; and
positioning a detector over the grated coupler that receives the redirected portion.

11. The method as recited in claim 10 wherein forming a grated coupler includes forming a grated coupler having a periodicity based on the equation:
$$Λ = \frac{λ}{( {n}_{eff} - cos θ )}$$
wherein Λ is the periodicity, λ is the operating wavelength of the device, n_{eff} is the index of refraction of the waveguide, and θ is a desired angle that the radiation exits the waveguide.

12. The method as recited in claim 11 wherein the desired angle ranges from about 45 degrees to about 160 degrees.

13. The method as recited in claim 11 wherein the periodicity ranges from about 400 nm to about 1200 nm.

14. The method as recited in claim 10 wherein forming a grated coupler includes forming a grated coupler at least partially within the waveguide.

15. The method as recited in claim 10 further including forming a dielectric layer over the waveguide, and wherein forming the grated coupler includes forming the grated coupler at least partially within the dielectric layer.

16. The method as recited in claim 10 wherein creating a waveguide within a substrate includes creating a metal diffused or proton exchanged waveguide within an electrooptic crystal substrate, and the method further includes forming an electrode adjacent the waveguide.

17. The method as recited in claim 10 wherein forming a grated coupler includes forming a grated coupler from a material selected from the group consisting of:
silicon dioxide;
calcium fluoride;
sapphire;
indium tin oxide; and
air.

18. The method as recited in claim 10 wherein creating a waveguide within a substrate includes creating a waveguide within a silicon or silica substrate.

19. The method as recited in claim 10 wherein positioning a detector includes positioning a photodetector over the grated coupler.

20. The method as recited in claim 10 further including coupling an optical waveguide to the optical device, wherein the optical device and the optical waveguide form at least a portion of an optical communications system.
